(19) United States
(12) Patent Application Publication
(10) Pub. No.: US 2020/0081912 A1
(43) Pub. Date: Mar. 12, 2020

(54) IDENTIFYING PHYSICAL OBJECTS USING VISUAL SEARCH QUERY

(71) Applicant: YesPlz, Inc., Sunnyvale, CA (US)

(72) Inventors: Jiwon Hong, Sunnyvale, CA (US); Sukjae Cho, Sunnyvale, CA (US)

(21) Appl. No.: 16/364,091

(22) Filed: Mar. 25, 2019

Related U.S. Application Data
(60) Provisional application No. 62/658,598, filed on Apr. 17, 2018.

(51) Int. Cl. G06F 16/44; G06F 16/2457; G06F 16/438; G06F 16/41; G06N 3/08; G06F 16/483; G06F 16/432

(52) U.S. Cl. CPC G06F 16/44; G06F 16/24578; G06F 16/438; G06F 16/434; G06N 3/08; G06F 16/483; G06F 16/41

(57) ABSTRACT

An online system uses a visual search query to identify physical objects received from a plurality of third-party systems that match component types specified in the visual search query. The online system receives physical object information from the plurality of third-party systems and determines component types associated with the received physical objects based on the physical object information. Based on neural networks, the online system determines an index that corresponds to a component type for each component of received physical objects. After receiving a visual search query specifying component types, the online system identifies physical objects that match the visual search query for displaying to a client device.

### CROSS REFERENCE TO RELATED APPLICATIONS

This application claims the benefit of U.S. Provisional Application No. 62/658,598 filed Apr. 17, 2018, which is incorporated by reference in its entirety.

### BACKGROUND

This disclosure relates generally to a method of searching across representations of objects, and specifically to searching across representations of physical objects based on visual search queries.

Online systems often store information and provide a search engine for allowing users to search through the information. Examples of stored information include documents, images, videos, representations of physical objects, and the like. Online systems often collect the stored information from a plurality of third-party systems. The search engines typically use one or more indexes for efficient searching for the stored information.

A search engine also provides an interface for allowing users to provide search queries, for example, an interface that allows users to enter a search query comprising keywords describing an object of interest to receive search results including a set of objects that the search engine determines to be relevant to the search query. The relevance of the search results may be determined based on a similarity between the entered keywords and information such as an image, a video, a text description, and tags associated with objects stored in the online system. Using the received keywords, the online system filters through information associated with objects stored in the database to select the set of objects that match the keywords. However, a keyword based search provides a poor user experience if a user desires physical objects having a particular type of appearance, for example, having specific shapes of components of the object. Providing such a description is cumbersome for a user. Even if a user provided such a description, conventional systems do not store indexes that allow search based on such queries since these keywords may not occur in the description of the object.

### SUMMARY

Embodiments relate to using a visual search query to receive specification of a type of physical object and to identify physical objects that match the received visual query. An online system stores information describing physical objects, for example, images and text descriptions describing physical objects from third-party systems. Each physical object comprises one or more components, each component having a component type.

The online system builds a visual search query using an image of a physical object. The online system receives a specification of a physical object type that indicates the category of physical objects for which the visual search query is being specified. Based on the specification of the physical object type, the online system displays a default image of an example physical object of that physical object type. For example, the online system generates the image by combining images corresponding to default component types of each component of a physical object of the specified physical object type. The online system iteratively receives via the user interface specifications of component types for one or more components. For example, the user interface allows a user to modify the component type of a selected component. Based on the received specification, the online system reconfigures the image of the example physical object to reflect the component type of the selected component. The online system sends the reconfigured image for display via a client device. Once the user completes modifying the image of the example physical object by iteratively modifying images of specific components, the reconfigured image represents the visual search query. The online system receives and processes the visual search query by identifying a set of physical objects that match the visual search query. The online system sends the identified set if physical objects as the search results of the visual search query.

In an embodiment, the online system stores a position of each component for each physical object type. The position of the component is relative to one or more other components of the physical object. The online system configures the image of the physical object by placing images of the components of the physical object in a user interface according to the stored position of each component.

In an embodiment, the online system determines a component type for each component of a physical object based on information received from third-party systems. The online system stores an index mapping component types for each of the components to corresponding physical objects. The online system uses the index to identify physical objects that match a visual search query.

In an embodiment, the online system generates the index using a plurality of neural network based models. Each neural network based model is configured to receive an input describing a physical object and predict a component type of a component of the input physical object. The input describing the physical object may comprise one or more of: text description of the physical object, image of the physical object, or metadata describing the object.

### BRIEF DESCRIPTION OF THE DRAWINGS

FIG. 1 is a block diagram of a system environment in which an online system operates, in accordance with an embodiment.

FIG. 2 is a conceptual diagram illustrating an example visual search query, in accordance with an embodiment.

FIG. 3 is a block diagram of an online system, in accordance with an embodiment.

FIG. 4 is a flowchart illustrating a process of searching for physical objects, in accordance with an embodiment.

FIG. 5 is a flowchart illustrating a process of creating an index system for a physical object, in accordance with an embodiment.

FIG. 6 is a flowchart illustrating a process of building a visual search query, in accordance with an embodiment.

FIGS. 7A-7D are example visual search queries, in accordance with an embodiment.

FIG. 8 illustrates an embodiment of a computing machine that can read instructions from a machine-readable medium and execute the instructions in a processor or controller.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Environment

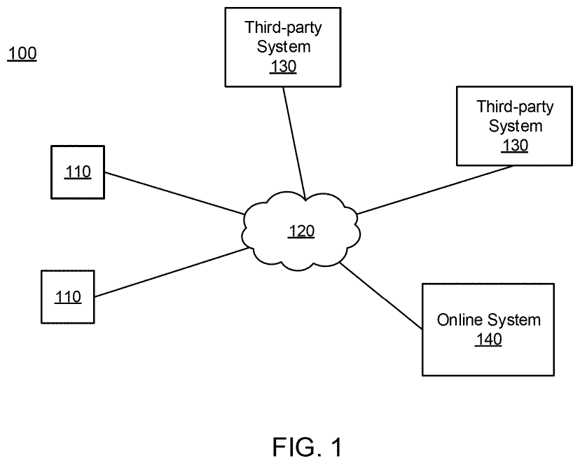

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The client devices 110, the third-party systems 130, and the online system 140 communicate with each other via the network 120.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate with the third-party systems 130 and the online systems 140 via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online system 140. In one embodiment, a third-party system 130 is an application provider communicating information describing applications for execution by a client device 110 or communicating data to client devices 110 for use by an application executing on the client device. In other embodiments, a third-party system 130 provides content or other information for presentation via the client devices 110. A third-party system 130 may also communicate information to the online system 140, such as advertisements, content, or information about an application provided by the third-party system 130.

A third-party system 130 may be an online system associated with a third-party and may manage physical objects information describing a plurality of physical objects associated with the third-party (e.g., products sold by the third-party). In some embodiments, the third-party system 130 is an online store for physical objects, each physical object having a physical object type (e.g., type of clothing such as a shirt, type of furniture such as chair). The third-party system 130 may receive requests to purchase one or more physical objects from a user and responsive to receiving the requests, may sell the one or more physical objects to the client devices 110 via the network 120. For each physical object associated with the third-party, the third-party system 130 may store physical object information describing the physical object. The physical object information may include one or more of text, image, audio, video, or any other suitable data presented to a user that describes the physical object. More specifically, for each physical object, the physical object information may include an image associated with the physical object, textual data describing attributes of the physical objects, tags associated with the physical objects, cost associated with the physical object, reviews of the physical object received by the third-party system 130, a landing page associated with the physical object, and metadata that at least identifies and describes the third-party system 130 that the physical object belongs to. Because each third-party system 130 is different, the contents of physical object information may vary within the third-party systems 130. Further, based on the availability of data within a third-party system 130, the physical object information associated with different physical objects from one third-party system 130 may also vary.

Each of the third-party systems 130 in the system environment 100 may provide a search interface that may be accessed by the client device 110 via the network 120 to browse through the physical objects of the third-party and the physical object information associated with the physical objects. However, when there is a large number of third-party systems 130 in the system environment 100 that provide information describing different physical objects, it is inconvenient and time consuming for users to make multiple search queries on search interfaces of third-party systems 130 in search of a physical object. Further, it is difficult to compare different physical objects across different search interfaces of the different third-party systems 130. For example, each third-party system may use a different set of metadata to represent the physical objects. That makes searching across different third-party systems using metadata based queries difficult for users. To centralize physical object searches, the one or more of the third-party systems 130 send physical object information to the online system 140 that processes search queries for physical objects and presents a set of physical objects matching the search queries based on physical object information received from the different third-party systems. The online system 140 allows users to build visual search queries using a graphical user interface that allows a user to build a visual representation of the search query indicating the types of physical objects that the user is interested in searching. A visual search query provides a user-friendly search interface for searching through physical objects since a user is able to visually represent as well as visualize the type of physical objects being searched. In contrast, a keyword search based interface requires users to textually describe the type of physical objects, thereby presenting users with a significant burden to use words to describe the types of physical objects desired.

In some embodiments, the third-party systems 130 sends physical object information about newly added physical objects that were not previously sent to the online system 140. The one or more third-party system 130 may also update or add to physical object information previously sent to the online system 140. For example, if an attribute associated with a physical object changes, the third-party system 130 may update the attribute information previously sent to the online system 140 to reflect the change to have consistent information between the third-party system 130 and the online system 140. Examples of attributes include a cost of the physical object, a size of the physical attribute, and so on. The third-party system 130 may send the information to the online system 140 periodically (e.g., every day, every week) or incrementally as new information is added from the third-party system 130.

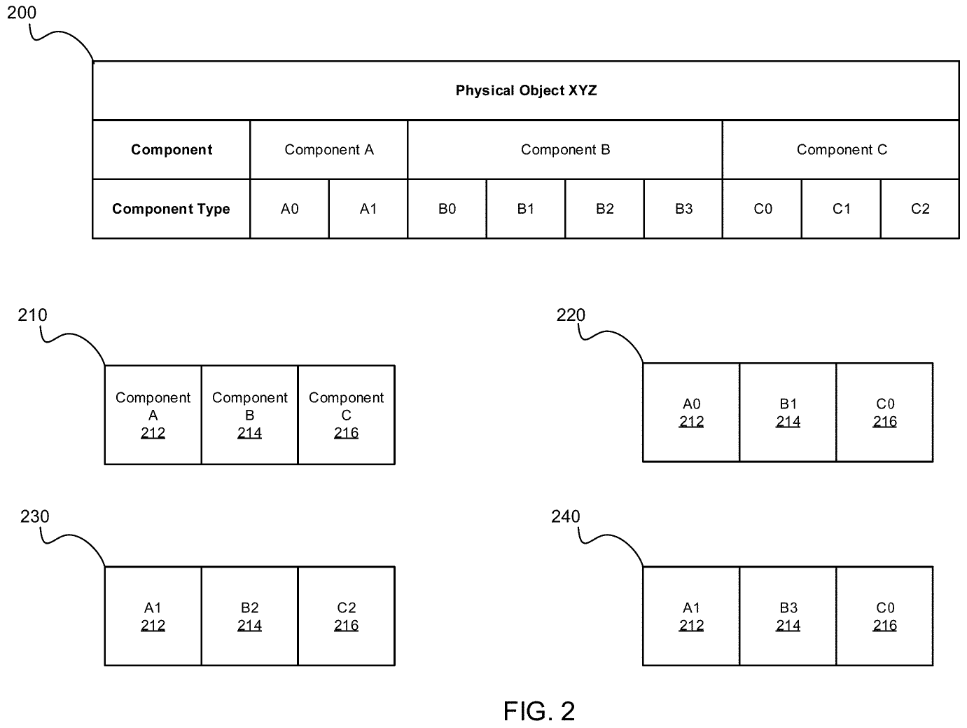

The online system 140 receives physical object information from the one or more third-party systems 130 and responsive to receiving a search query for physical objects from a client device 110, displays physical objects that match the search query. The online system 140 identifies the matching physical objects based on physical object information received from the third-party systems 130. The online system 140 has a search interface included in a user interface that may be accessed by the client device 110 for entering a search query. In some embodiments, the search interface is a visual search interface that receives a visual search query represented using an image of a physical object. In other embodiments, the search interface may allow receiving a search query using one or more of text, image, and voice entry. Details on the visual search interface is discussed below with respect to FIG. 2.

Responsive to receiving the search query, the online system 140 identifies physical objects that satisfy search parameters defined by the search query or determines that there are no physical objects that satisfy the parameters. The online system 140 displays a result of the search query by displaying the matching physical objects to the client device 110 or displays a message that there are no matching search results. In some embodiments, the online system 140 may display a portion of the physical object information when displaying the physical objects. For example, the online system 140 may retrieve an image associated with the physical object and a short text description of the physical object rather than the physical object information in its entirety.

After displaying the results of matching physical objects, the online system 140 may receive a request from the client device 110 for additional information associated with one of the matching physical objects from the client device 110. Responsive to the request, the online system 140 may display additional physical object information associated with the selected physical object via a content page of the online system 140 that includes physical object information received from the third-party system 130 associated with the selected physical object. In some embodiments, the online system 140 directs the client device 110 to a content page of the third-party system 130 instead of displaying directly on the user interface of the online system 140.

FIG. 2 is a conceptual diagram illustrating an example visual search query, in accordance with an embodiment. In a given physical object, there is a plurality of components that make up the physical object. Further, for each component, there is a plurality of possible component types that are each associated with unique physical attributes.

In some embodiments, the online system 140 may receive a search query for a particular physical object of a particular physical object type from a client device 110 via a visual search interface. The online system 140 may present an example image of a physical object of the received physical object type on the visual search interface that may be modified based on user input of component types via the client device 110. Prior to receiving specification of the component types, the example image may be generated using a default component type for each of the component types of the physical object. The example image may be divided into portions, where each portion of the example image is associated with a component of the plurality of components. The online system 140 stores relative positions of various components of physical objects of a particular physical object type. For example, a physical object type may be a shirt comprising components such as collar, sleeves, a body, and so on. The online system 140 stores relative positions of these component, for example, where a collar is attached to the body and where each sleeve is attached to the body. The relative position of the components allows the online system to compose images of individual components to obtain an image of the overall physical object. In an embodiment, the online system 140 stores structural information describing each component, for example, as one or more geometrical shapes including points, segments, or splines. The online system uses the structural information to describe a relative position of one component with respect to another component. For example, the online system 140 may store information indicating that a particular segment of a first component representing a first side of the component is attached to a segment representing a second side of a second component. Accordingly, each portion of the example image is associated with a position on the example image relative to at least another portion of the example image. A user interface displayed via the client device 110 allows users to interact with the example image to specify a component type for one or more of the components, for example, by modifying a given default component type of a component to another component type.

In the example shown in FIG. 2, a physical object XYZ 200 has three components that make up the physical object: a component A, a component B, and a component C. Other physical objects 200 may include fewer or additional components. In the example shown in FIG. 2, component A has two possible component types: AO and Al, component B has four possible component types: B0, B1, B2, and B3, and component C has three possible component types: C0, C1, and C2. Depending on the possible variations in a physical object, the number of components and the number of component types may vary. In some embodiments, each of the components may have fewer or additional possible component types.

The online system 140 updates the displayed example image 210 to reflect the received specification of component types for one or more of the components of the physical object. Component A is associated with a left portion, component B is associated with a middle portion, and component C is associated with a right portion of the physical object XYZ. Furthermore, the online system stores information describing the different sides of each component and information indicating that the right side of component A is attached to the left side of component B and the left side of component C is attached to the right side of component B. In a first physical object 220, the component type for component A is A0, the component type of component B is B1, and the component type of component C is C0. In a second physical object 230, the component type of component A is A1, the component type of component B is B2, and the component type of component C is C2. In a third physical object 240, the component type of component A1, the component type of component B is B3, and the component type of component C is C0. Although not shown in FIG. 2, in some embodiments, one or more of the components may not receive a component type selection. For example, a component type of component A may be selected as A0, a component type of component B may be selected as B1, and a component type of component C may not be specified.

Responsive to receiving the component types, the example image 210 may be reconfigured based on the specification of the component types. The online system 140 accesses an image for each component type of each component, and reconfigures the image 210 by displaying a corresponding image of the component type at the appropriate position of the example image.

### System Architecture

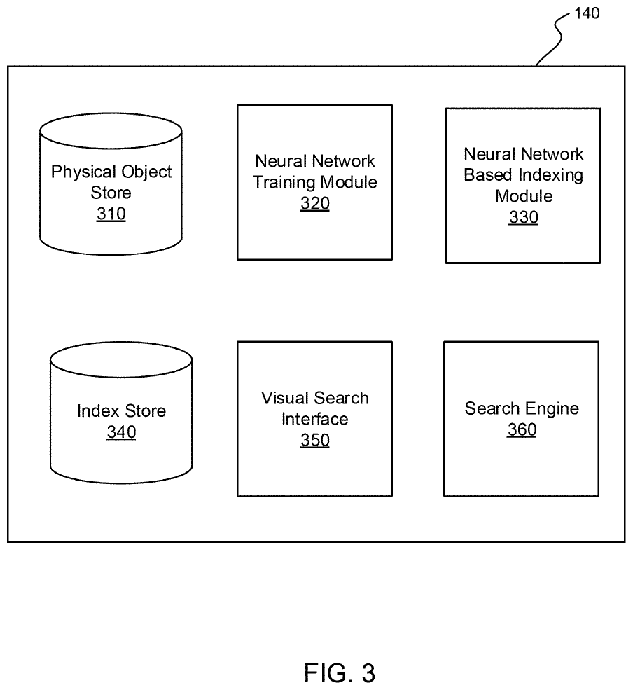

FIG. 3 is a block diagram of an architecture of the online system 140. The online system 140 shown in FIG. 3 includes a physical object store 310, a neural network training module 320, a neural network based indexing module 330, an index store 340, a visual search interface 350, and a search engine 360. In other embodiments, the online system 140 may include additional, fewer, or different components for various applications.

The physical object store 310 stores physical object information associated with one or more physical objects received by the online system 140. The physical object information may be received from a plurality of third parties 130. The physical object information may include one or more of images, texts, videos, links, and metadata that describes the associated physical object. In some embodiments, the physical object store 310 stores training information associated with one or more training physical objects used to train one or more models in a neural network used in the neural network based indexing module 330. The training information may include sets of annotated inputs and outputs for the neural network training module 320 such that one or more neural networks of the neural network based indexing module 330 may learn mappings between a set of inputs and a set of outputs according to a function for each of the one or more neural networks using the training information. The physical object store 310 may further store a set of default physical objects for each physical object type in the physical object store 310 for presenting via the visual search interface 350 prior to receiving a specification of physical object components. Each of the default physical objects have default component types.

The neural network training module 320 receives training information describing one or more training physical objects and trains neural networks of the neural network based indexing module 330 using the received training information. In a given physical object type, there is a plurality of components that make up the physical object type, where each component has a plurality of possible component types. In the neural network based indexing module 330, there may be at least a neural network for each component of each physical object. The neural network training module 320 trains the neural networks in the neural network based indexing module 330 such that the neural networks may identify a component type for each of the components of the physical object based on input provided to the neural network based indexing module 330 by the physical object store 310. The component type may be represented using an index.

During the training process, the neural network training module 320 determines the mapping functions between the inputs such that the one or more neural networks may transform the inputs (e.g., physical object information) to the outputs (e.g., component type for a component). The component types may be represented using an index system such that for each component of a physical object, there is a plurality of possible component types, each of the component types corresponding to an index value. The mapping may be represented by a set of weights that is combined with the received inputs to translate the inputs to the outputs. The neural network training module 320 trains the neural networks in the neural network based indexing module 330 to determine connections between nodes within the neural networks such that the neural network based indexing module 330 may accurately identify component types based on physical object information provided to the online system 140.

In some embodiments, the neural network training module 320 may receive a test set of physical objects that includes input and expected output of the neural network training module 320 to determine the accuracy of the trained neural network. The neural network training module 320 may provide physical object information as input to the test set output verification that indicates whether the index prediction for the test set determined by the neural network training module 320 is correct. The neural network training module 320 compares the results by the neural network training module 320 to the expected outputs. Depending on the comparison of the predicted results and the actual results of the training data, the weights of the neural network are adjusted using back-propagation.

The neural network based indexing module 330 receives physical object information and generates an index entry for each component of a physical object based on the received physical object information. The neural networks used by the neural network based indexing module 330 are trained by the neural network training module 320. Based on the neural network training performed by the neural network training module 320, the neural network based indexing module 330 identifies an index for each component of a physical object. The index corresponds to a particular component type that describes physical characteristics of the component.

In some embodiments, the neural network based indexing module 330 may include a pre-processing unit (not shown) that processes physical object information received from the physical object store 310. Since the online system 140 receives physical object information from different third-party systems 130, there may be high variability in physical object information received for different physical objects. The pre-processing unit may normalize the physical object information received across the different third-party systems and prepare the physical object information to be used as inputs to the neural networks of the neural network based indexing module 330.

After determining the index entry associated with each of the components of the physical objects, the neural network based indexing module 330 sends the determined index entries to the index store 340. The index store 340 stores the received index entries associated with physical objects. In some embodiments, the index store 340 stores a mapping from each component type to identifiers associated with representations of physical objects that have a particular component type. If the online system 140 receives a visual search query represented as an image of the physical object, the online system 140 determines the component types of each component shown in the image of the physical object. The online system 140 uses the index to identify the subset of physical objects that have all or at least some of the components matching the components types specified by the visual search query.

The visual search interface 350 is a user interface of the online system 140 that receives visual search queries from client devices 110 and displays physical objects that match the search queries. In some embodiments, a specification of physical object type is received by the online system 140 from a client device to initiate a search query. Based on the received physical object type, the online system 140 retrieves an example image of the physical object type to present on the visual search interface 350. In some embodiments, the example image of the physical object is based on default component types associated with the physical object type stored in the physical object store 310. The example image of the physical object may be divided into a plurality of portions, each portion corresponding to a component of the physical object. Each portion is at a particular position of the physical object with respect to the other portions of the example image.

Based on the presented example image of the physical object, the visual search interface 350 receives specification of component types based on inputs to the portions of the example image. Referring back to the example shown in FIG. 2, the physical object XYZ 200 has a physical object type that may be represented by an example image 210. The example image 210 has a first portion 212 associated with component A, a second portion 214 associated with component B, and a third portion 216 associated with component C. The example image 210 may be presented via the visual search interface 350 to a client device 110. Each component corresponds to a position on the physical object XYZ 200 with respect to other components of the physical object XYZ 200. For example, component A 212 is associated with a leftmost position, component B is associated with a middle position, and component C is associated with a rightmost position.

The visual search interface 350 of the online system may display the example image 210, where the example image 210 has one or more graphical elements (not shown in FIG. 2) for receiving specification of component type for one or more of the component A, component B, and component C. One or more of the components of the example image 210 may receive an interaction from the client device 110 specifying a component type. In one example, there may be a drop-down menu for a component that lists possible component types for selecting a component type. Within the drop-down menu, there may be a representative icon for each component type such that a user may visually compare characteristics of the possible component types and select a component type based on the characteristics. When a component type is selected for a component, the first portion 212 of the example image 210 may be modified to reflect the selected component type.

In another example, each component type of a component may be associated with a number of times that a user interacts with the portion of the example image 210 corresponding to the component (e.g., click on the portion corresponding to the component). For example, for component A, A0 may correspond to one click performed with the first portion 212, and A1 may correspond to two clicks performed with the first portion 212. Similarly, for component B, B0 may correspond to one click performed with the second portion 214, B1 to two clicks, B2 to three clicks, and B3 to four clicks. Accordingly, the online system 140 stores a sequence number for each component type of a component and each click with the component causes the user interface to display an image corresponding to the next component type in the sequence. In other embodiments, different interactions may be used for specifying the component types.

In another example, the online system 140 displays an image for each of the possible component types for each component in a user interface (e.g., in a sidebar) responsive to receiving a specification of a physical object type. An image may be dragged and dropped onto the example image 210 to specify a component types for a component of the physical object. Responsive to the image representing a component type for a particular component being dropped onto the example image 210, the image may be snapped to a position of the physical object that corresponds to the particular component.

In another example, the online system 140 provides a virtual sketch pad in a user interface to receive a sketch of a component of a particular component type from a user. The user interface may provide a plurality of drawing tools such as a virtual pen, eraser, paintbrush, shapes, color editor, and such for receiving the sketch of the one or more component types. Based on the received sketch, the online system 140 uses image recognition to predict the component type associated with the received sketch. In some embodiments the online system 140 receives a partial sketch of a component of a particular component type. The online system 140 performs image completion to predict a full image of an object, given the partial sketch provided by the user. The partial sketch may be an incomplete drawing of the component or a complete drawing that is roughly drawn. In an embodiment, the online system 140 uses a neural network based model that predicts a full image, given a partial image. The neural network based model may be trained using pairs of partial and corresponding full images. In an embodiment, the online system 140 matches the partial sketch against images of components of various component types stored in the online system to select the best matching image. The online system 140 may request the user to approve the predicted image before using the component type of the component specified by the user for performing visual search, for example, by asking a question requesting whether the completed image is what the user specified. In some embodiments, the online system 140 may determine a confidence score for the predicted component type. If the confidence score is below a threshold, the online system 140 may present the predicted component type on the user interface and request verification of the predicted component type. If the confidence score is above a threshold, the online system 140 may automatically modify the example image 210 to reflect the component type. In some embodiments, the online system 140 presents a plurality of top ranking images that have the highest confidence and lets the user select one of the presented image.

The visual search interface 350 may also display input fields for receiving additional details about physical objects for the visual search query. In some embodiments, the additional details are associated with physical attributes of the physical objects. For example, the additional details may be a specification of material, print pattern, and color of a physical object of interest for the visual search query. In other embodiments, the additional details may be associated with non-physical attributes of the physical objects such as brand, price range, availability, whether physical objects are on sale, and user ratings.

The search engine 360 compares component types received in the search query to the visual search interface 350 and identifies physical objects that satisfy the search query. The search engine 360 compares the received indices representing the component types to information stored in the index store 340. In some embodiments, the search engine 360 accesses the index store 340 to determine whether there are physical objects that match at least a threshold number of indices. In other embodiments, the search embodiments, the search engine 360 determines an overall score for physical objects where each component is associated with a weight and the overall score is a sum of the weights of the different components of the physical object.

After determining the physical objects that match the search query, the search engine 360 generates a search result for displaying to client devices 110 via the visual search interface 350. In some embodiments, the search engine 360 accesses physical object information in the physical object store 310 and presents the search results in a results feed. The results feed may be organized based on a score associated with the physical objects, the score representing a similarity of the physical object to the search query. For example, a physical object that matches all component types specified by a visual search query is likely to have higher score compared to another physical object that matches only some of the component types specified by the visual search query. In other embodiments, the search engine 360 ranks the matching physical object using a weighted aggregate of a plurality of factors. For example, the online system 140 may consider a factor representing a popularity score for each of the physical objects based on physical object information received from the third parties. The popularity scores may be based on conversion history of the physical objects received from the third parties, sponsored by the third parties, ratings received by users, and such.

### Overall Process for Identifying a Set of Physical Objects for Display

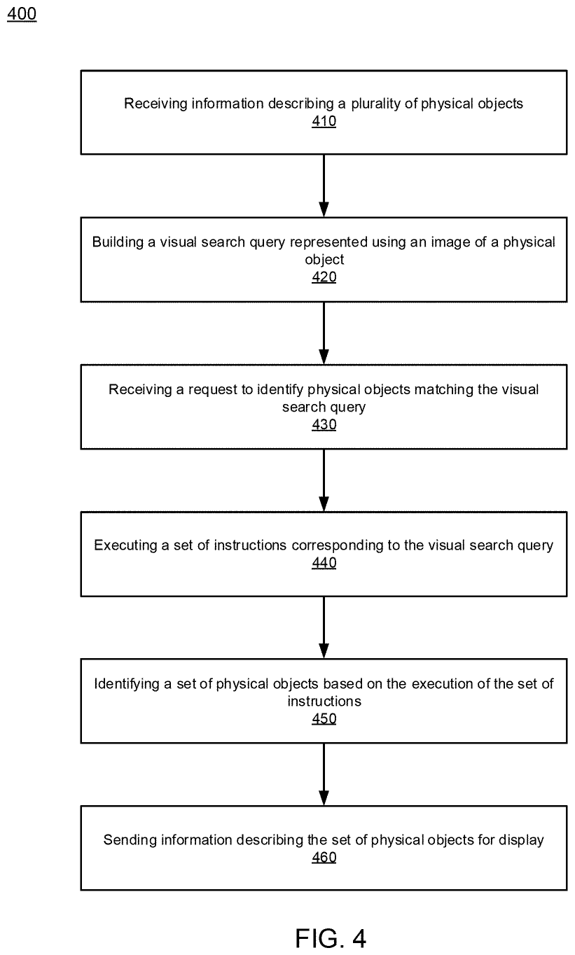

FIG. 4 is a flowchart illustrating a process of searching for physical objects, in accordance with an embodiment. An online system receives 410 information describing a plurality of physical objects. The information describing the plurality of physical objects may be received from a plurality of third-party systems and includes one or more of text description of the physical objects, images of the physical objects, and metadata describing the physical object. Each physical object of the plurality of physical objects has a physical object type that describes a category that the physical object belongs to (e.g., a shirt, a shoe, a vehicle, a type of furniture, a computer, a mechanical device, plants and so on). In an embodiment, the online system 140 stores a hierarchy of categories of physical object types such that each object can be classified using one or more categories in the hierarchy. A physical object may have a plurality of components (e.g., a shirt may have components including a sleeve, collar, body, hem, a plant may have components including flowers, leaves, stems, fruits) that make up the physical object. The physical object information received from the third-party systems is stored in the physical object store 310.

The physical object information is provided to the neural network based indexing module 330 that determines an index for each of the components of a physical object. In some embodiments, the physical object information is an image and a text description of the physical object provided as input to the neural networks in the neural network based indexing module 330 for predicting component types for the physical object. Each component may have a plurality of possible component types, where each component type may be represented using an index. Once the indices for the component types of the objects are determined by the neural networks, the indices are stored in an index store of the online system such that during a search query, the online system may search through the store indices and identify physical objects that match the search query from the index store.

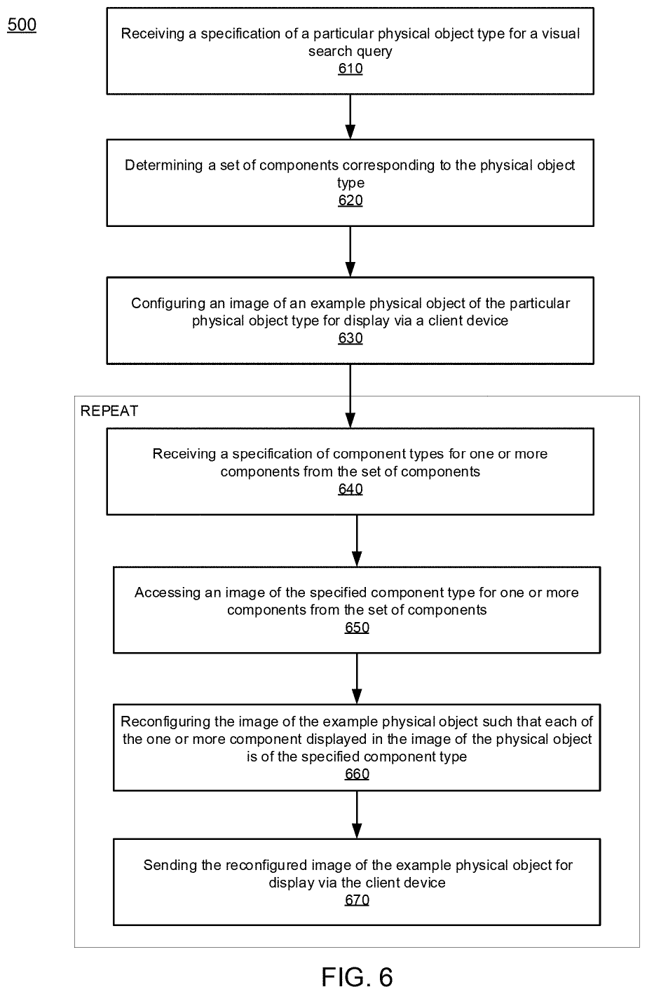

The online system builds 420 a visual search query represented using an image of a physical object. The online system receives specification of component types from a client device via a visual search interface of the online system. The details of building the visual search query is described below with respect to FIG. 6.

The online system receives 430 a request to identify physical objects matching the visual search query. Based on the visual search query of the physical object, the online system compares the received component types with physical object indices stored in the index store of the online system.

The online system executes 440 a set of instructions corresponding to the visual search query. The set of instructions may include accessing the index store and identifying physical objects that match the search query.

The online system identifies 450 a set of physical objects based on the execution of the set of instructions. In some embodiments, the online system identifies a physical object to include in the set of physical objects to display to the client device by determining a number of component types of the physical object that matches the search query. In some embodiments, the online system determines a score for each of the physical objects stored in the index store and presents the physical objects that exceed a threshold score.

The online system sends 460 information describing the set of physical objects for display. Based on the identified set of physical objects, the online system accesses physical object information received from the third-party systems and stored in the physical object store.

### Process for Generating an Index System for Physical

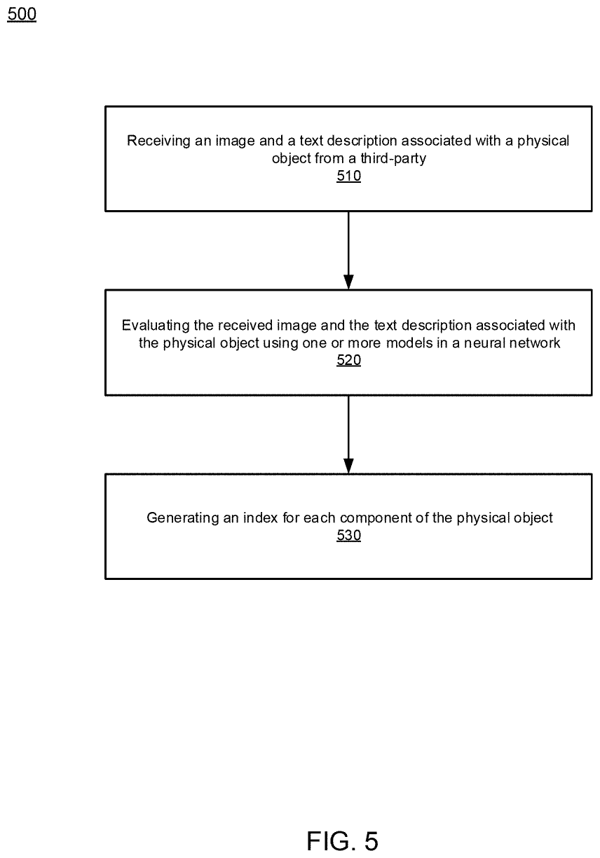

FIG. 5 is a flowchart illustrating a process of creating an index system for a physical object, in accordance with an embodiment.

An online system receives 510 an image and a text description associated with a physical object from a third-party. In some embodiments, there may be fewer or additional information received by the online system for creating the index system.

The online system evaluates 520 the received image and the text description associated with the physical object using one or more models in a neural network. The models in the neural network are in a neural network based indexing module 330 that takes the received image and the text description associated with the physical object as input and generates an index entry for each of the components as output for storing in an index. As discussed below, the raw image and text description data may be provided to the neural network based indexing module 330 or may be pre-processed by the neural network based indexing module 330 before being input to the neural networks. Based on the input, the neural network based indexing module 330 determines an index entry that represents a component type for each component such that an index including an index entry for each component may be stored for identification of a physical object.

The online system generates 530 an index entry for each component of the physical object. In some embodiments, the neural network based indexing module 330 includes a pre-processing component that evaluates image and text description and generates a normalized input for the one or more models in the neural network. In some embodiments, the received image and text description are encoded and provided as input to the neural network for generating the index entry for each component of the physical object. The generated index entries are stored in the index store 340 to be used in identifying physical objects that match a search query received from a client device.

### Process for Building Visual Search Query

FIG. 6 is a flowchart illustrating a process of building a visual search query, in accordance with an embodiment. The online system receives 610 a specification of a particular physical object type for a visual search query. The particular physical object type describes a category of physical object. The specification of the particular physical object type may be received via a visual search interface.

The online system determines 620 a set of components corresponding to the physical object type. For each of the physical object types in the online system, there may be a different set of components that make up the physical object type. For a given physical object type, the online system may store a default set of components. The default set of components may be received from third parties or generated by the online system based on training data used to train models for the neural network.

The online system configures 630 an image of an example physical object of the particular physical object type for display via a client device. The online system may display the image of the example physical object based on the default set of components. Each of the components are associated with a position on the physical object with respect to the other components of the physical object. The image of the example physical object is generated by accessing an image of each of the default components and building the image of the example physical object by putting the image of the default component in the respective position.

The online system receives 640 a specification of a particular component type for one or more components from the set of components. The online system has a visual search interface, and the online system receives the specification of component types from a client device via the visual search interface. The specification of the component types may be based on interactions to the image of the example physical object. The image of the example physical object may include visual elements that the client device may interact with to define the component types.

The online system accesses 650 an image of the specified component type for one or more components from the set of components. The image of the specified component type may be stored in a physical object store. The image of the specified component type may be received from one or more third-party systems or generated by the online system based on training data.

The online system reconfigures 660 the image of the example physical object such that each of the one or more component displayed in the image of the physical object is of the specified component type. Based on the received specification of component types, the online system updates one or more components on the image of the example physical object. The online system 140 may repeat the steps 640, 650, 660, and 670 multiple times, depending on the number of times the user wants to modify the components types of components of the example physical object.

The online system sends 670 the reconfigured image of the example physical object for display via the client device. The reconfigured image of the example physical object may be presented with a plurality of physical objects that at least includes the specified component type. In some embodiments, the reconfigured image is generated in each iteration of steps 640, 650, 660, and 670. For example, if a user specifies a component type for a first component, the system accesses an image of the specified component type and reconfigures the image of the example physical object in real time to reflect the specified component type for the first component. If a user then specifies a component type for a second component, the system accesses an image of the specified component type and reconfigures the image of the example physical object in real time to reflect the specified component type for the second component in addition to the first component. In some embodiments, the online system reconfigures the image of the example physical object after a predetermined time delay following a specification of a component type (e.g., 1 second after receiving a specification). In some embodiments, the online system updates the plurality of physical objects presented to the client device responsive to additional specification of a component type.

In one example, a physical object type is a shirt, and the set of components corresponding to the shirt may is a neckline, a body portion, and sleeves. For the shirt component type, the default component types may be a round neckline, a body portion that covers an entire torso, and short sleeves. An example image with the default component types may be generated and displayed on a visual search interface. In a visual search query, a client device may specify that a desired component type for the sleeve is a bell shaped sleeve. Responsive to the specification, the online system may access an image of the bell shaped sleeve and update the example image to include the bell shaped sleeve. If the client device further specifies that the component type of the neckline is a v-neck style, the updates the plurality of physical objects presented to the client device to at least include the bell shaped sleeve and the v-neck style.

### Example Visual Search Queries

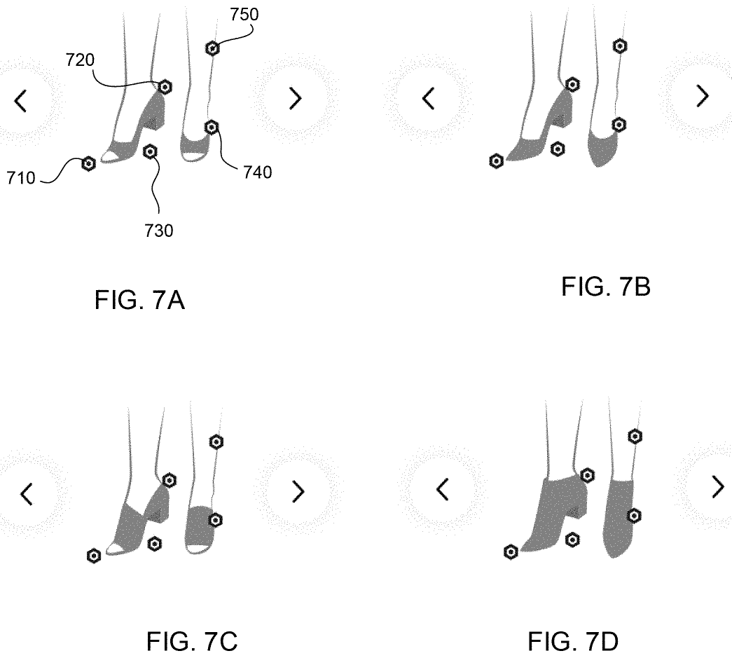

FIGS. 7A-7D are example visual search queries, in accordance with an embodiment. In each of the following example visual search queries, the physical object type of interest is a shoe which has a set of associated components. The shoe has a first component 710, a second component 720, a third component 730, a fourth component 740, and a fifth component 750. The physical object type may have fewer or additional components than what is shown in FIGS. 7A-7D. Each of the components has a plurality of possible component types such that there is a range of possible combinations of component types for the visual search queries. An example image of the physical object type (e.g., shoe) is displayed on the visual search interface. A user may interact with the example image displayed on the visual search interface via a client device and modify the example image to specify particular component types to build a visual search query. Based on the received component types in the visual search query, an online system identifies and displays physical objects that match the visual search query.

In some embodiments, the image shown in FIG. 7A may be a default image for the physical object type of a shoe. The online system may receive a specification of physical object type as a shoe from a client device. The default image shown in FIG. 7A may be displayed on a visual search interface via a client device responsive to receiving the physical object specification.

In a first visual search query, the online system may receive an interaction to the first component 710 of the default image and modify the first component type. As shown in FIG. 7A, the default component type for the first component type may be open toe. The visual search interface may receive an interaction to specify the first component type as pointed closed toe. Responsive to a request to update the first component type to closed toe, the online system may access an image of the closed toe component type stored in a physical object store and reconfigure the visual search query to include the access image of the closed toe as shown in FIG. 7B.

In a second visual search query, the online system may receive an interaction to the third component type 740 of the default image to modify the third component type. As shown in FIG. 7A, the default component type for the third component type is to have an open surface for the back of the foot. The visual search interface may receive an interaction to specify the third component type as closed surface. Responsive to a request to update the third component type to closed surface, the online system may access an image of the close surface component type stored in the physical object store and reconfigure the visual search query to include the accessed image of the closed surface as shown in FIG. 7C

In a third visual search query, the online system may receive an interaction to the first component type 710, second component type 720, and the third component type 740. As shown in FIG. 7A, the default component type for the first component type is open toe, the default for the second component type is open surface, and the default for the third component type is uncovered ankle. The visual search interface may receive an interaction to specify the first component type as closed toe, the second component type as closed surface, and the third component type as closed ankle. Responsive to a request to update the component types, the online system may access an image of the closed toe, the closed surface, and the closed ankle and reconfigure the visual search query to include the accessed images as shown in FIG. 7D.

### Computing Machine Architecture

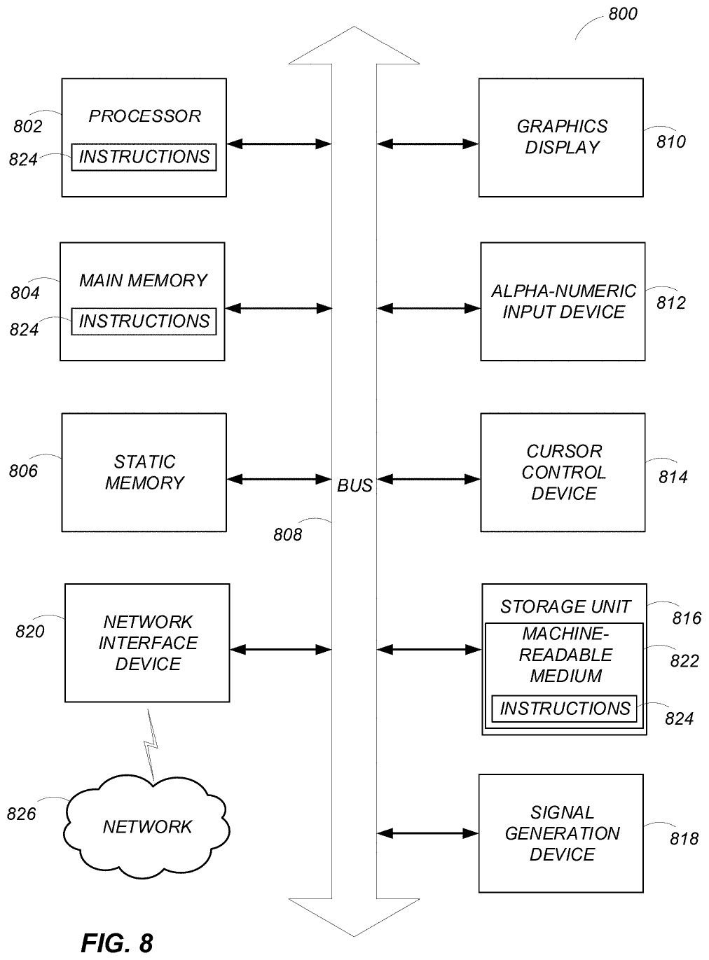

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
storing, by an online system, information describing a plurality of physical objects, each physical object associated with a physical object type, wherein each physical object comprises a set of components, each component associated with a component type;
receiving, from a client device, a specification of a particular physical object type;
determining a set of components corresponding to the particular physical object type;
building a visual search query for physical objects of the particular physical object type, the building comprising:
configuring a default image of an example physical object of the particular physical object type by composing a set of images, each image displaying a component from the set of components associated with a default component type;
sending the default image for display via the client device;
iteratively modifying the image of the example physical object, comprising, repeating:
receiving a request to modify a component type of a selected component; and
reconfiguring the image of the example physical object using an image of the selected component associated with the modified component type; and
sending the reconfigured image for display via the client device;
configuring the visual search query based on a description of the example physical object corresponding to the modified image;
identifying a set of physical objects having components matching the visual search query; and
sending information describing the set of physical objects for display via the client device.

2. The method of claim 1, further comprising:
for each physical object type, for each component of a physical object of the physical object type, storing a position of the component with respect to one or more other components of the physical object,
wherein configuring the image of the physical object comprises placing images of the components of the physical object in a user interface according to the stored position of each component.

3. The method of claim 1, further comprising:
storing, by the online system, an index mapping a representation of each of the plurality of physical objects to a set of components types, wherein each of the set of component types corresponds to a component of the physical object; and
accessing representations of physical objects having one or more components matching the set of component types specified by the visual search query based on the index.

4. The method of claim 3, further comprising:
generating the index using a plurality of neural network based models, each neural network based model configured to receive an input describing a physical object and predict a component type of a component of the physical object.

5. A method comprising:
receiving, by an online system from a plurality of external systems, information describing a plurality of physical objects, each physical object having a physical object type, each physical object comprising a set of components, each component having a component type;
receiving, by the online system from a client device, a specification of a particular physical object type for a visual search query;
for each of one or more components of the physical object type, receiving, from the client device, a specification of a particular component type;
configuring an image of an example physical object, the image of the example physical object obtained by composing images of each of the components from the set of components, the images of each of the one or more components corresponding to the specification of the particular component type received from the client device;
sending the image of the example physical object for display via the client device;
receiving a request to identify physical objects having components matching the physical object specified by the visual search query;
identifying a set of physical objects based on the request; and
sending information describing the set of physical objects for display via the client device.

6. The method of claim 5, further comprising:
for each physical object type, for each component of a physical object of the physical object type, storing a position of the component with respect to one or more other components of the physical object, and
wherein configuring the image of the physical object comprises placing in a user interface, images of the components of the physical object according to the stored position of each component.

7. The method of claim 5, further comprising:
storing, by the online system, an index mapping a representation of each of the plurality of physical objects to a set of components types, wherein each of the set of component types corresponds to a component of the physical object; and
accessing representations of physical objects having one or more components matching the set of component types specified by the visual search query based on the index.

8. The method of claim 7, wherein the index is generated using neural network based models trained to receive input describing a physical object and predict a component type of a component of the physical object.

9. The method of claim 8, wherein the input describing the physical object comprises one or more of:
text description of the physical object,
image of the physical object, or
metadata describing the object.

10. The method of claim 5, further comprising:
receiving, by the online system from the plurality of external systems, the information describing the plurality of physical objects; and
storing, for each of the plurality of physical objects, metadata identifying the external system that provided information describing the physical object.

11. The method of claim 5, further comprising:
for each physical object of the plurality of physical objects, generating a weighted combination of values associated with the set of components of the physical object;
ranking the plurality of physical objects based on the weighted combinations; and
displaying at least a subset of the plurality of physical objects via the client device based on the ranking.

12. The method of claim 5, further comprising:
determining a popularity score for each of the plurality of physical objects based on the received information describing the physical objects from the plurality of external systems;
ranking the plurality of physical objects based on the popularity scores; and
displaying at least a subset of the plurality of physical objects via the client device based on the ranking.

13. A non-transitory computer readable medium storing instructions that when executed by a processor of a display manufacturing system cause the processor to:
receive information describing a plurality of physical objects, each physical object having a physical object type, each physical object comprising a set of components, each component having a component type;
receive a specification of a particular physical object type for a visual search query;
for each of one or more components of the physical object type, receive, from the client device, a specification of a particular component type;
configure an image of an example physical object, the image of the example physical object obtained by composing images of each of the components from the set of components, the images of each of the one or more components corresponding to the specification of the particular component type received from the client device;
send the image of the example physical object for display via the client device;
receive a request to identify physical objects having components matching the physical object specified by the visual search query;
identify a set of physical objects based on the request; and
send information describing the set of physical objects for display via the client device.

14. The computer readable medium of claim 13, further storing instructions that cause the processor to:
for each physical object type, for each component of a physical object of the physical object type, store a position of the component with respect to one or more other components of the physical object,
wherein configuring the image of the physical object comprises placing in a user interface, images of the components of the physical object according to the stored position of each component.

15. The computer readable medium of claim 13, further storing instructions that cause the processor to:
store an index mapping a representation of each of the plurality of physical objects to a set of components types, wherein each of the set of component types corresponds to a component of the physical object; and
access representations of physical objects having one or more components matching the set of component types specified by the visual search query based on the index.

16. The computer readable medium of claim 15, wherein the index is generated using neural network based models trained to receive input describing a physical object and predict a component type of a component of the physical object.

17. The computer readable medium of claim 16, wherein the input describing the physical object comprises one or more of:
text description of the physical object,
image of the physical object, or
metadata describing the physical object.

18. The computer readable medium of claim 13, further storing instructions that cause the processor to:
receive the information describing the plurality of physical objects; and
store metadata identifying an external system that provided information describing the physical object.

19. The computer readable medium of claim 13, further storing instructions that cause the processor to:
for each physical object of the plurality of physical objects, generate a weighted combination of values associated with the set of components of the physical object;
rank the plurality of physical objects based on the weighted combinations; and
display at least a subset of the plurality of physical objects via the client device based on the ranking.

20. The computer readable medium of claim 13, further storing instructions that cause the processor to:
determine a popularity score for each of the plurality of physical objects based on the received information describing the physical objects from the plurality of external systems;
rank the plurality of physical objects based on the popularity scores; and
display at least a subset of the plurality of physical objects via the client device based on the ranking.
